(19) United States
(12) Patent Application Publication
(10) Pub. No.: US 2009/0225281 A1
(43) Pub. Date: Sep. 10, 2009

(54) PROJECTION DISPLAY SYSTEM AND PRISM SET AND MANUFACTURING METHOD THEREOF

(76) Inventors: Ching-Hsiang YU, Taoyuan Hsien (TW); Ming-Cheng Lee, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/240,792

(22) Filed: Sep. 29, 2008

(30) Foreign Application Priority Data
Mar. 7, 2008 (TW) 97108183

(51) Int. Cl. G03B 21/28; G02B 5/04

(52) U.S. Cl. 353/81; 359/831; 359/834

(57) ABSTRACT

The present invention provides a projection display system and a prism set and manufacturing method thereof. The method for manufacturing the prism set includes the steps of providing a first prism, a second prism, a third prism and a fourth prism, wherein the length of the first prism is greater than that of the second prism, and the lengths of the third prism and the fourth prism are greater than that of the first prism, and assembling the first prism, the second prism, the third prism and the fourth prism together to form a prism assembly.

The present application claims priority under U.S.C. §119(a) on Patent Application No(s) 97108183. filed in Taiwan, Republic of China on Mar. 7, 2008, the entire contents of which are hereby incorporated by reference.

### BACKGROUND OF THE INVENTION

1. Field of the Invention

The invention relates to a projection display system, a prism set and a manufacturing method thereof and, in particular, to a prism assembly for improving efficiency of light-combining.

2. Description of the Related Art

Present rear projector and rear projection TV systems include three types of systems, digital light processing (DLP) systems, liquid-crystal display (LCD) systems, and liquid crystal on silicon (LCoS) systems. Due to prism sets are applied to LCD systems and LCoS systems to combine light, the demand of prism sets have increased.

Referring to FIG. 1, it shows a base structure of a conventional projector. The conventional projector comprises three liquid-crystal light valves 42, 44, and 46, a prism set 48, and a projection lens 50. A red reflective film 48R intersects a blue reflective film 48B to form an X shape. Three primary colors, red, blue and green, are combined via the prism set 48 and then adjusted by the liquid-crystal light valves 42, 44, and 46 for illuminating a combined light beam toward the projection lens 50. The combined light beam is focused on a projection screen 52 via the projection lens 50.

The prism set 48 is formed by four equal-sized prisms adhered to each other However, when adhering four equal-sized prisms for forming the prism set 48, it is difficult to accurately adhere the prisms and keep the red reflective film 48R and the blue reflective film 48B on the same plane, respectively, thereby influencing the reflective and transparent characteristics of the red reflective film 48R and the blue reflective film 48B. As such, the prism set 48 is deficient. Additionally, when the deficient prism set is applied to a projector, multiple images, various-sized images or stripes generated by light scattering appear on the projection image.

### BRIEF SUMMARY OF THE INVENTION

The invention provides a projection display system, a prism set and a manufacturing method thereof for improving light-combining efficiency.

To achieve the above, the invention provides a method for manufacturing a prism set. The steps include: providing a first prism, a second prism, a third prism and a fourth prism, wherein the length of the first prism is greater than that of the second prism, and the lengths of the third prism and the fourth prism are greater than that of the first prism; and assembling the first prism, the second prism, the third prism and the fourth prism together to form a prism assembly.

The first prism and the second prism are assembled via a first tool to form a first assembly, and a plane of the first assembly is completely attached to a plane of the first tool. When the first prism is assembled with the second prism, the lengths of the two protruding sides of the first prism are almost the same.

The first assembly formed by the first prism and the second prism is assembled with the third prism via a second tool to form a second assembly and a plane of the second assembly is completely attached to a plane of the second tool. When the first assembly is assembled with the third prism, the lengths of the two protruding sides of the third prism are almost the same. The second tool comprises a hole, the length of the second tool corresponds to the length of the second prism, and the width of the second tool is two times greater than the width of the second prism. Alternatively, the second tool comprises a hole, the hole comprises a first portion and a second portion, the length of the first portion of the hole corresponds to the length of the first prism, the length of the second portion of the hole corresponds to the lengths of the third prism and the fourth prism, and the width of the hole is two times greater than the width of the second prism.

The second assembly formed by the first prism, the second prism, and the third prism is assembled with the fourth prism via a third tool to form the prism assembly, and a plane of the prism assembly is completely attached to a plane of the third tool. Two sides of the third prism are aligned to two sides of the fourth prism. The second tool comprises a hole, the length of the third tool corresponds to the length of the first prism, and the width of the third tool is two times greater than the width of the fourth prism.

The lengths of the third prism and the fourth prism are similar.

A join between the first prism and the second prism, and a join between the third prism and the fourth prism respectively have a first optical film. The two first optical films are disposed on the same surface. A join between the first prism and the third prism, and a join between the second prism and the fourth prism respectively have a second optical film. The two second optical films are disposed on the same plane. The first optical films intersect the second optical films to form an x shape in the prism set, and a central intersection of the first optical films and the second optical films is discontinuous.

A connecting surface of the first prism is plated with the first optical film, a connecting surface of the fourth prism is plated with the second optical film, and two connecting surfaces of the third prism is respectively plated with the first optical film and the second optical film.

The first optical film comprises a red reflective film and the second optical film comprises a blue or a green reflective film. The first optical film and the second optical film are formed via deposition or sputtering process. The first prism, the second prism, the third prism and the fourth prism are adhered via epoxy, UV adhesive or adhesive. The first prism, the second prism, the third prism and the fourth prism are a pillar-shaped prism with a cross section of an isosceles triangle, a right-angled and equilateral triangle, or a right-angled and non-equilateral triangle.

The method for manufacturing the prism set further includes a step of cutting the prism assembly to form one or more prism sets.

To achieve the above, the invention provides a prism set. The prism set includes a first prism, a second prism, a third prism and a fourth prism. The first prism, the second prism, the third prism and the fourth prism are assembled to each other. A join between the first prism and the second prism, and a join between the third prism and the fourth prism respectively have a first optical film. The two first optical films are disposed on the same plane. A join between the first prism and the third prism, and a join between the second prism and the fourth prism respectively have a second optical film. The two second optical films are disposed on the same plane. The first optical films intersect the second optical films to form an x shape in the prism set, and a central intersection of the first optical films and the second optical films is discontinuous.

To achieve the above, the invention provides a projection display system. The projection display system includes a light source, a color-separating apparatus separating light from the light source for color separation, a light adjuster adjusting the separated light according to an image signal to form an adjusted light, and a prism set combining the adjusted light to form a combined light beam. The prism set includes a first prism, a second prism, a third prism and a fourth prism. The first prism, the second prism, the third prism and the fourth prism are assembled to each other. A join between the first prism and the second prism, and a join between the third prism and the fourth prism respectively have a first optical film. The two first optical films are disposed on the same plane. A join between the first prism and the third prism, and a join between the second prism and the fourth prism respectively have a second optical film. The two second optical films are disposed on the same plane. The first optical films intersect the second optical films to form an x shape in the prism set, and a central intersection of the first optical Films and the second optical films is discontinuous.

The projection display system further comprises a projection lens to focus the combined light beam on a projection screen.

The projection display system further comprises a UV-IR filter to filter ultraviolet and infrared light from the light source.

The color-separating apparatus includes a polarization conversion system, a plurality of dichroic filters, and a plurality of reflector. The light adjuster comprises a liquid-crystal light valve, a polarizer, or a control panel.

### BRIEF DESCRIPTION OF DRAWINGS

The present invention will become more fully understood from the subsequent detailed description and accompanying drawings, which are given by way of illustration only, and thus are not limitative of the present invention, and wherein:

FIG. 1 is a schematic view of a base structure of a conventional projector;

FIGS. 2A to 2K are schematic views of a method for manufacturing a prism set according to the present invention;

FIG. 3 is a schematic view of a tool applied to a method for manufacturing another prism set according to the present invention; and

FIG. 4 is a schematic view of an embodiment of an LCD projection display system according to the present invention.

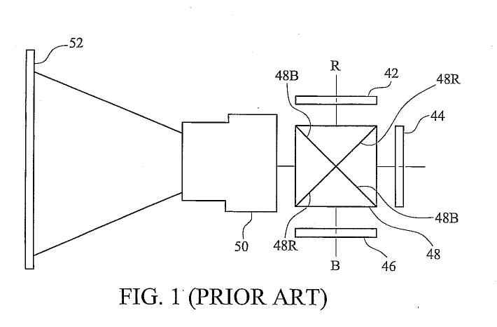

### DETAILED DESCRIPTION OF THE INVENTION

Referring to the related drawings, a projection display system and a prism set and manufacturing method thereof is described according to the preferred embodiments of the invention. The same elements are labeled with the same symbols.

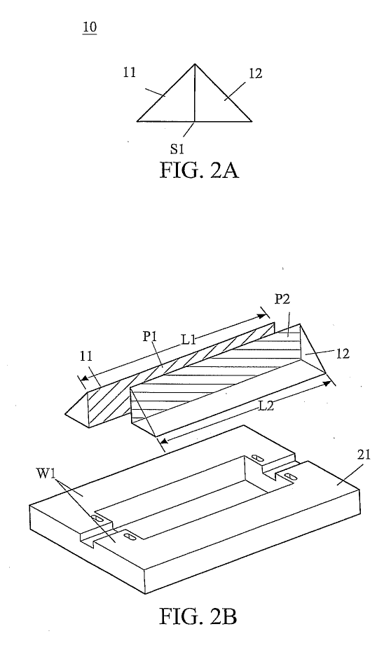

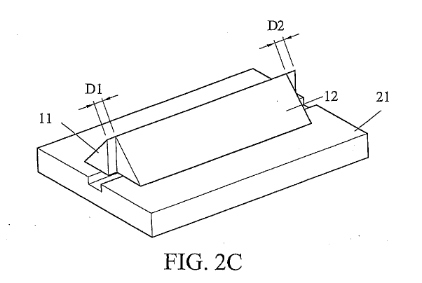

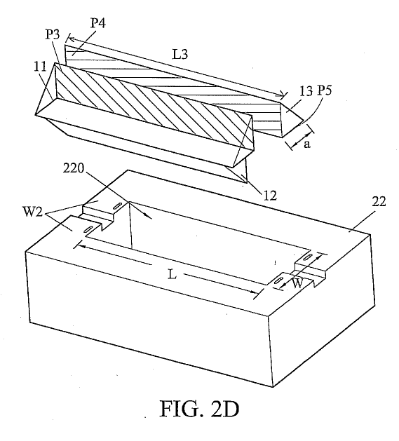

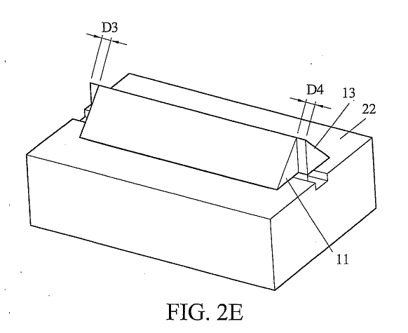

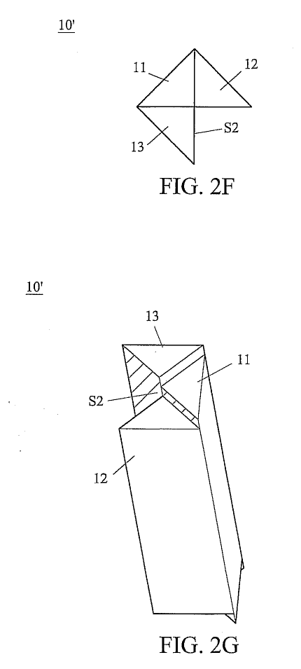

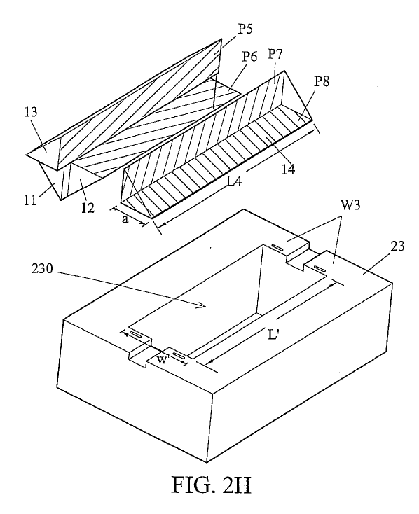

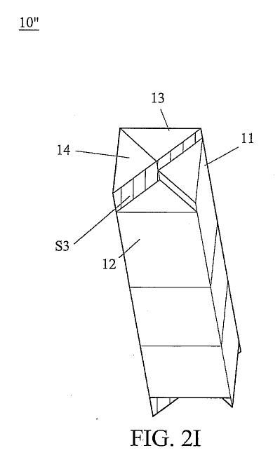

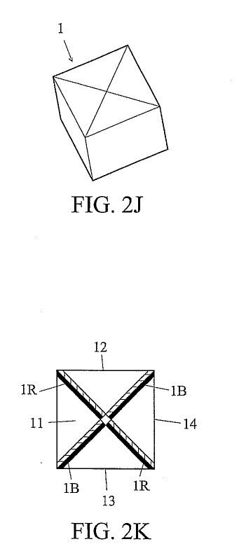

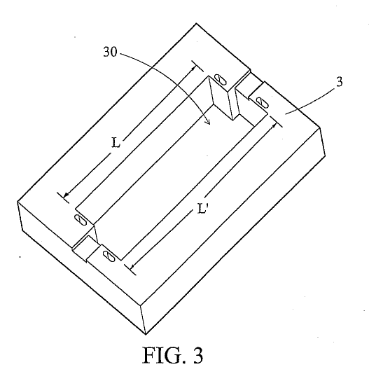

Referring to FIGS. 2A to 2K, they show a method for manufacturing a prism set according to the present invention. As shown in FIGS. 2A to 2C, the method includes the steps of: providing a first prism (or named a long prism) 11 and a second prism (or named a short prism) 12. The length L1 of the long prism 11 is greater than the length L2 of the short prism 12. A connecting surface P1 of the long prism 11 is plated with the first optical film (in this embodiment, the first optical film is, for example, a red reflective film formed via deposition or sputtering process) and connected to a connecting surface P2 of the short prism 12 via an assembling tool 21. The connection material includes epoxy, UV adhesive or adhesive. A plane S1 of an assembly 10 formed by the long prism 11 and the short prism 12 is completely attached to a plane W1 of the assembling tool 21 for minimizing deviation between the long prism 11 and the short prism 12 to increase the coplanarity of the plane S1. When assembling, it is necessary to ensure that the lengths D1 and D2 of two protruding sides of the long prism 11 are almost the same for a smooth manufacturing process.

Referring to FIGS. 2D to 2G, the method includes the steps of: providing a third prism (or named a extra-long prism) 13. The length L3 of the extra-long prism 13 is greater than the length L1 of the long prism 11 and the length L2 of the short prism 12. A connecting surface P4 of the extra-long prism 13 is plated with the second optical film (in this embodiment, the second optical film is, for example, a blue reflective film) and a connecting surface P5 of the extra-long prism 13 is plated with the first optical film (in this embodiment, the first optical film is, for example, a red reflective film). The blue reflective film is formed via deposition or sputtering process. A connecting surface P3 of the assembly 10 is connected to the connecting surface P4 of the extra-long prism 13 to form an assembly 10′ via a tool 22. A plane S2 of the assembly 10′ is completely attached to a plane W2 of the tool 22 for minimizing deviation between the long prism 11 and the extra-long prism 13 to increase the coplanarity of the plane S2. When assembling, it is necessary to ensure that the lengths D3 and D4 of two protruding sides of the extra-long prism 13 are almost the same for a smooth manufacturing process. The tool 22 comprises a hole 220, the length L of the hole 220 of the tool 22 corresponds to or is slightly greater than the length L2 of the short prism 12 to provide a maximum support surface on the plane S2 to support the plane W2. The width W of the hole 220 is two times greater than the width a of the short prism 12 to prevent the tool 22 from interference of the the short prism 12.

Referring to FIGS. 2H to 2I, the method includes the step of: providing a fourth prism (or named a extra-long prism) 14. The length L4 of the extra-long prism 14 is equal to the length L3 of the extra-long prism 13. A connecting surface P8 of the extra-long prism 14 is plated with the second optical film (in this embodiment, the second optical film is, for example, a blue reflective film). A connecting surface P5 and a connecting surface P6 of the assembly 10′ are connected to two connecting surfaces P7 and P8 of the extra-long prism 14 to form an assembly 10″ via a tool 23. A plane S3 of the extra-long prism 14 is completely attached to a plane W3 of the tool 23 for minimizing deviation between the extra-long prism 13 and the extra-long prism 14 to increase the coplanarity of the plane S3. When assembling, it is necessary to ensure that two sides of the extra-long prism 14 are aligned to two sides of the extra-long prism 13. The tool 23 includes a hole 230, the length L′ of the hole 230 of the tool 23 corresponds to the length L1 of the long prism 11 to provide a maximum support surface on the plane S3 to support the plane W3. The width W′ of the hole 230 is two times greater than the width a of the extra-long prism 14 to prevent the tool 23 from interference of the long prism 11.

The long prism 1, the short prism 12, the extra-long prisms 13 and 14 may be a pillar-shaped prism with a cross section of an isosceles triangle, a right-angled and equilateral triangle or a right-angled and non-equilateral triangle.

Referring to FIG. 2I, the assembly 10″ is cut along the dotted line to form the prism set 1, as shown in FIG. 2J. The long prism set 1 can be cut into several prism sets. As shown in FIG. 2K, it shows a sectional view of the prism set 1 according to FIG. 2J. The red reflective films 1R intersects the blue reflective films 1B to form an x shape in the prism set 1, and a central intersection of the red reflective films 1R and the blue reflective films 1B is discontinuous. The positions of the red reflective films 1R and the blue reflective films 1B can be exchanged. Further, different colors can be adapted. In this embodiment, the blue reflective film can be replaced with, for example but not limited to, a green reflective film.

Referring to FIG. 3, it shows a tool applied to a method for manufacturing another prism set according to the present invention. The method for manufacturing the prism set is approximately similar to the above-mentioned embodiment. The difference is that the tools 22 and 23 are integrated as a tool 3. The tool 3 includes a hole 30. The hole 30 includes a first portion and a second portion. The length L of the first portion corresponds to the length L1 of the long prism 11 (the length L of the first portion is less than the length L1 of the long prism 11 but is greater than the length L2 of the short prism 12). The length L′ of the second portion corresponds to the length L3 of the extra-long prism 13 (the length L′ of the second portion is less than the length L3 of the extra-long prism 13 but is greater than the length L3 of the extra-long prism 13). The width of the hole 230 is two times greater than the width of the prism.

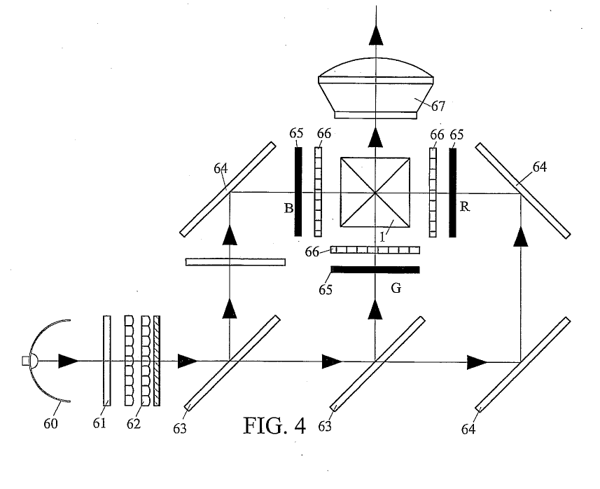

Referring to FIG. 4, it shows an embodiment of an LCD projection display system according to the present invention. The LCD projection display system includes a light source 60; a color-separating apparatus separating light from the light source for color separation; three light adjusters adjusting the separated light according to an image signal to form an adjusted light; and a prism set 1 combining the adjusted light to form a combined light beam. The prism set 1 is a finished light-combining product cut via the above-mentioned method.

The projection display system further includes a UV-IR filter 61 to filter ultraviolet and infrared light from the light source. The projection display system further includes a projection lens 67 which focuses the combined light beam on a projection screen. The color-separating apparatus includes a polarization conversion system 62, a plurality of dichroic filters 63 and a plurality of reflectors 64. The light adjuster includes a liquid-crystal light valve, a polarizer or a control panel.

In the operation of the projection display system, the light source 60 emits light to the UV-IR filter 61 to filter UV and IR light. Then, light enters the polarization conversion system 62 and passes through a series of dichroic filters 63 and reflectors 64. Finally, light enters the prism set 1 via the polarizer 65 and LCD panel 66 to combine red light, blue light, and green light to form white light so as to emit white light to the projection lens 67.

In summary, the method for manufacturing the prism set according to the present invention ensures that the red reflective film and the blue reflective film are accurately positioned on the same plane, thereby substantially improving reflective and transparent characteristics so as to enhance the prism set characteristics. Furthermore, when the prism set of the present invention is applied to a projection display system, the size of the projection display system can be decreased. The surfaces of the four pillar-shaped prisms of the prism set are plated with the reflective film before being assembled. Accordingly, if one of the prisms fails to be plated, the other prisms do not need to be replaced, thereby reducing product cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for manufacturing a prism set comprising the steps of:
providing a first prism, a second prism, a third prism and a fourth prism, wherein the length of the first prism is greater than that of the second prism, and the lengths of the third prism and the fourth prism are greater than that of the first prism; and
assembling the first prism, the second prism, the third prism and the fourth prism together to form a prism assembly.

2. The manufacturing method as claimed in claim 1, wherein the first prism and the second prism are assembled via a first tool to form a first assembly, a plane of the first assembly is completely attached to a plane of the first tool, and when the first prism is assembled with the second prism, the lengths of the two protruding sides of the first prism are almost the same.

3. The manufacturing method as claimed in claim 2, wherein the first assembly formed by the first prism and the second prism is assembled with the third prism via a second tool to form a second assembly, a plane of the second assembly is completely attached to a plane of the second tool, and when the first assembly is assembled with the third prism, the lengths of the two protruding sides of the third prism are almost the same.

4. The manufacturing method claimed in claim 3, wherein the second tool comprises a hole, the length of the hole of the second tool corresponds to the length of the second prism, and the width of the hole of the second tool is two times greater than the width of the second prism.

5. The manufacturing method claimed in claim 3, wherein the second tool comprises a hole, the hole comprises a first portion and a second portion, the length of the first portion of the hole corresponds to the length of the first prism, the length of the second portion of the hole corresponds to the lengths of the third prism and the fourth prism, and the width of the hole is two times greater than the width of the second prism.

6. The manufacturing method claimed in claim 3, wherein the second assembly formed by the first prism, the second prism and the third prism is assembled with the fourth prism via a third tool to form the prism assembly, a plane of the prism assembly is completely attached to a plane of the third tool, and two sides of the third prism are aligned to two sides of the fourth prism.

7. The manufacturing method claimed in claim 6, wherein the third tool comprises a hole, the length of the hole of the third tool corresponds to the length of the first prism, and the width of the hole of the third tool is two times greater than the width of the fourth prism.

8. The manufacturing method claimed in claim 1, wherein the lengths of the third prism and the fourth prism are equal.

9. The manufacturing method claimed in claim 1, wherein a join between the first prism and the second prism, and a join between the third prism and the fourth prism respectively have a first optical film, the two first optical films are disposed on the same plane, a join between the first prism and the third prism, and a join between the second prism and the fourth prism respectively have a second optical film, the two second optical films are disposed on the same plane, the first optical films intersect the second optical films to form an x shape in the prism set, and a central intersection of the first optical films and the second optical films is discontinuous.

10. The manufacturing method claimed in claim 9, wherein a connecting surface of the first prism is plated with the first optical film, a connecting surface of the fourth prism is plated with the second optical film, and two connecting surfaces of the third prism is respectively plated with the first optical film and the second optical film.

11. The manufacturing method claimed in claim 9, wherein the first optical film and the second optical film are formed via deposition or sputtering process, the first optical film is a red reflective film and the second optical film is a blue or green reflective filial.

12. The manufacturing method claimed in claim 1, wherein the first prism, the second prism, the third prism and the fourth prism are adhered with each other via epoxy, UV adhesive or adhesive.

13. The manufacturing method claimed in claim 1, wherein the first prism, the second prism, the third prism and the fourth prism are a pillar-shaped prism with a cross section of an isosceles triangle, a right-angled and equilateral triangle, or a right-angled and non-equilateral triangle.

14. The manufacturing method claimed in claim 1, further comprising a step of cutting the prism assembly to form one or more prism sets.

15. A prism set comprising:
a first prism, a second prism, a third prism and a fourth prism;
wherein the first prism, the second prism, the third prism and the fourth prism are assembled with each other, a join between the first prism and the second prism, and a join between the third prism and the fourth prism respectively have a first optical film, the two first optical films are disposed on the same plane, a join between the first prism and the third prism, and a join between the second prism and the fourth prism respectively have a second optical film, the two second optical films are disposed on the same plane, the first optical films intersect the second optical films to form an x shape, and a central intersection of the first optical films and the second optical films is discontinuous.

16. The prism set claimed in claim 15, wherein the first prism, the second prism, the third prism and the fourth prism are adhered with each other via epoxy, UV adhesive or adhesive.

17. The prism set claimed in claim 15, wherein the first prism, the second prism, the third prism and the fourth prism are a pillar-shaped prism with a cross section of an isosceles triangle, a right-angled and equilateral triangle, or a right-angled and non-equilateral triangle.

18. The prism set claimed in claim 15, wherein the first optical film comprises a red reflective film, the second optical film comprises a blue or a green reflective film, and the first optical film and the second optical film are formed via deposition or sputtering process.

19. A projection display system comprising:
a light source;
a color-separating apparatus separating light from the light source;
a light adjuster adjusting the separated light according to an image signal to form an adjusted light; and
a prism set combining the adjusted light to form a combined light beam;
wherein the prism set comprises a first prism, a second prism, a third prism and a fourth prism, the first prism, the second prisms the third prism and the fourth prism are assembled with each other, a join between the first prism and the second prism, and a join between the third prism and the fourth prism respectively have a first optical film, the two first optical films are disposed on the same plane, a join between the first prism and the third prism, and a join between the second prism and the fourth prism respectively have a second optical film, the two second optical films are disposed on the same plane, the first optical films intersect the second optical films to form an x shape, and a central intersection of the first optical films and the second optical films is discontinuous.

20. The projection display system claimed in claim 19, further comprising a projection lens to focus the combined light beam on a projection screen, and a UV-IR filter to filter ultraviolet and infrared light from the light source.

21. The projection display system claimed in claim 19, wherein the color-separating apparatus comprises a polarization conversion system, a plurality of dichroic filters, and a plurality of reflectors.

22. The projection display system claimed in claim 19, wherein the light adjuster comprises a liquid-crystal light valve, a polarizer, or a control panel.
